(19) United States
(12) Patent Application Publication
(10) Pub. No.: US 2025/0088119 A1
(43) Pub. Date: Mar. 13, 2025

(54) Interleaved Active Neutral Point Clamped (ANPC) Circuit

(71) Applicant: Santak Electronic (Shenzhen) Co., Ltd., Shenzhen (CN)

(72) Inventors: Lei Cao, Shenzhen (CN); Dan Liu, Shenzhen (CN); Huahong Ning, Shenzhen (CN); Dawei Zheng, Shenzhen (CN); Yulong Hao, Shenzhen (CN)

(21) Appl. No.: 18/816,155

(22) Filed: Aug. 27, 2024

(30) Foreign Application Priority Data
Sep. 12, 2023 (CN) 202311171527.6

(51) Int. Cl. H02M 7/487; H02M 1/00; H02M 7/219; H02M 7/5387

(52) U.S. Cl. CPC H02M 7/487; H02M 1/0043; H02M 7/219; H02M 7/53871

(57) ABSTRACT

Provided is an interleaved active neutral point clamped (ANPC) circuit including N (N≥2) parallel bridge arms, including: direct current (DC) terminals, including a positive and a negative DC terminal; an alternating current (AC) terminal; a switching circuit connected between the positive DC terminal and the negative DC terminal and including a first, a second, a third, and a fourth switching transistor sequentially connected in series, series nodes of the first, the second, the third, and the fourth switching transistor being sequentially a first, a second, and a third node, where the second node is connected to a neutral line; and N parallel high-frequency switching circuits connected between the first node and the third node, each of the N high-frequency switching circuits including a first and a second high-frequency switching transistor connected in series, where a phase difference between two adjacent high-frequency switching circuits among the N high-frequency switching circuits is 2π/N.

### CROSS-REFERENCE TO PRIORITY APPLICATION

This application claims priority to Chinese Patent Application No. 202311171527.6, filed Sep. 12, 2023, the content of which is hereby incorporated herein by reference in its entirety.

### TECHNICAL FIELD

The present inventive concept belongs to the field of electric power sources, and particularly relates to an interleaved ANPC circuit.

### BACKGROUND

In scenarios with high-voltage and high-power output, a neutral point clamped (NPC) multi-level inverter topology and an active neutral point clamped (ANPC) multi-level inverter topology are usually used. Specifically, ANPC circuits can implement high-efficiency and high-quality power conversion.

Interleaved circuits, which can reduce input current ripples and switching losses, are widely used in multi-phase converters. For example, if each phase of a system is composed of N bridge arms connected in parallel, a phase difference of 2π/N is used between every two adjacent bridge arms to drive a gate circuit. However, existing interleaved ANPC circuits have many switching devices, complex structures, low power density, high cost, and low thermal balance performance.

### SUMMARY

In view of this, the objective of the present inventive concept is to overcome shortcomings of the prior art and provide an interleaved ANPC circuit including N parallel bridge arms, where N≥2, the interleaved ANPC circuit includes: DC terminals, including a positive DC terminal and a negative DC terminal; an AC terminal; a first switching circuit connected between the positive DC terminal and the negative DC terminal and including a first switching transistor, a second switching transistor, a third switching transistor, and a fourth switching transistor sequentially connected in series, series nodes of the first switching transistor, the second switching transistor, the third switching transistor, and the fourth switching transistor being sequentially a first node, a second node, and a third node, where the second node is connected to a neutral line; and N parallel high-frequency switching circuits connected between the first node and the third node, each of the N high-frequency switching circuits including a first high-frequency switching transistor and a second high-frequency switching transistor connected in series, where a phase difference between two adjacent high-frequency switching circuits among the N high-frequency switching circuits is 2π/N.

According to the interleaved ANPC circuit of the present inventive concept, preferably, frequencies of the first switching transistor, the second switching transistor, the third switching transistor, and the fourth switching transistor are power frequencies.

According to the interleaved ANPC circuit of the present inventive concept, preferably, the first switching transistor, the second switching transistor, the third switching transistor, and the fourth switching transistor are IGBTs or MOSFETs.

According to the interleaved ANPC circuit of the present inventive concept, preferably, frequencies of the first high-frequency switching transistor and the second high-frequency switching transistor are greater than or equal to 1 kHz.

According to the interleaved ANPC circuit of the present inventive concept, preferably, the first high-frequency switching transistor and the second high-frequency switching transistor are SiC or GaN MOSFETs.

According to the interleaved ANPC circuit of the present inventive concept, preferably, further including N LC filtering circuits, a first terminal of each of the N LC filtering circuit is connected to a node between the first high-frequency switching transistor and second high-frequency switching transistor of a corresponding high-frequency switching circuit, and a second terminal of each of the N LC filtering circuits is connected to the AC terminal.

According to the interleaved ANPC circuit of the present inventive concept, preferably, the N LC filtering circuits share one capacitor or share a plurality of parallel capacitors.

According to the interleaved ANPC circuit of the present inventive concept, preferably, a phase difference between first high-frequency switching transistors of the two adjacent high-frequency switching circuits among the N high-frequency switching circuits is 2π/N, and a phase difference between second high-frequency switching transistors of the two adjacent high-frequency switching circuits among the N high-frequency switching circuits is 2π/N.

According to the interleaved ANPC circuit of the present inventive concept, preferably, the interleaved ANPC circuit is configured to perform DC-AC conversion or AC-DC conversion.

According to the interleaved ANPC circuit of the present inventive concept, preferably, the first switching circuit and the high-frequency switching circuits are configured to perform the following operations: during a positive half cycle, the first switching transistor and the third switching transistor are turned on, the second switching transistor and the fourth switching transistor are turned off, and the first high-frequency switching transistor and the second high-frequency switching transistor are alternately turned on; and during a negative half cycle, the first switching transistor and the third switching transistor are turned off, the second switching transistor and the fourth switching transistor are turned on, and the first high-frequency switching transistor and the second high-frequency switching transistor are alternately turned on. Compared with the prior art, the interleaved ANPC circuit of the present inventive concept has a simple structure, low cost, high power density, and high thermal balance performance.

### BRIEF DESCRIPTION OF THE DRAWINGS

The following further illustrates the embodiments of the present inventive concept with reference to the accompanying drawings.

FIG. 1 illustrates a circuit topology of an interleaved ANPC circuit according to some embodiments of the present inventive concept;

FIG. 2 illustrates a pulse width modulation (PWM) waveform diagram of switching transistors T1-T6 according to some embodiments of the present inventive concept;

FIG. 3 illustrates an output voltage waveform diagram according to some embodiments of the present inventive concept; and

FIG. 4 illustrates a circuit topology of an interleaved ANPC circuit according to some embodiments of the present inventive concept.

### DETAILED DESCRIPTION

In order to make the objectives, technical solutions and advantages of the present inventive concept clearer, the present inventive concept will be further described in detail below in conjunction with the accompanying drawing through specific embodiments. It should be understood that the specific embodiments described here are only used for interpreting the present inventive concept, rather than limiting the present inventive concept.

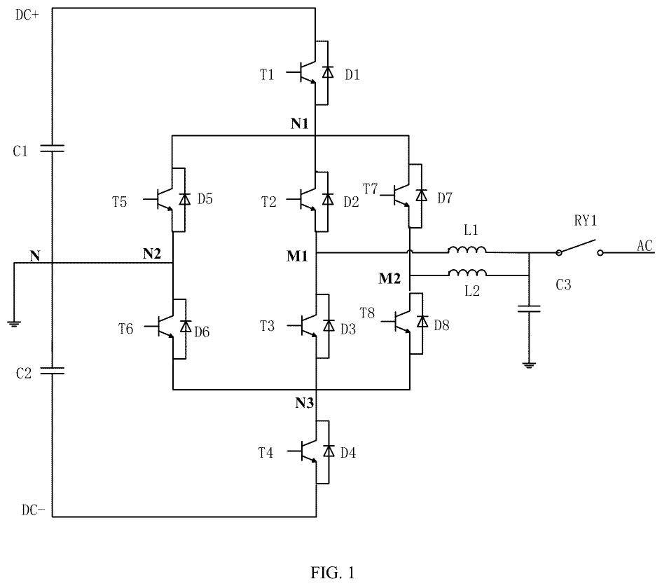

Some embodiments of the present inventive concept provides an interleaved ANPC circuit including two parallel bridge arms, with a circuit topology as shown in FIG. 1, including 8 switching transistors T1-T8, 8 diodes D1-D8, 3 capacitors C1-C3, 2 inductors L1-L2, and a relay RY1. A first terminal (collector) of T1 is connected to a direct-current positive bus DC+, a second terminal (emitter) of T1 is connected to first terminals of T2, T5, and T7 to form a node N1, a first terminal of T4 is connected to second terminals of T3, T6, and T8 to form a node N3, a second terminal of T5 is connected to a first terminal of T6 to form a node N2, a second terminal of T2 is connected to a first terminal of T3 to form a node M1, a second terminal of T7 is connected to a first terminal of T8 to form a node M2, a second terminal of T4 is connected to a direct-current negative bus DC−, the node N2 is connected to a neutral point N of a direct-current bus, the node M1 is connected to an AC terminal through the inductor L1 and the relay RY1, the node M2 is connected to the AC terminal through the inductor L2 and the relay RY1, a node between the inductor L1 and the relay RY1 is grounded through the capacitor C3, the capacitor C1 is connected between the DC+ and the neutral point N, the capacitor C2 is connected between the DC− and the neutral point N, and T1-T8 are anti-parallel to D1-D8 respectively, where T1 and T4-T6 are power-frequency switching transistors, and T2-T3 and T7-T8 are high-frequency switching transistors. Specifically, frequencies of T1 and T4-T6 are 50 Hz or 60 Hz, and frequencies of T2-T3 and T7-T8 are higher than 1 kHz, preferably higher than 10 kHz, and more preferably higher than 30 kHz.

In these embodiments, the switching transistors T1-T6, the diodes D1-D6, the capacitors C1-C3, the inductor L1, and the relay RY1 form a first bridge arm circuit; the switching transistors T1 and T4-T8, the diodes D1 and D4-D8, the capacitors C1-C3, the inductor L2, and the relay RY1 form a second bridge arm circuit; a first high-frequency switching series circuit of the first bridge arm circuit is connected in parallel to a second high-frequency switching series circuit of the second bridge arm circuit, and a phase difference between the both is, that is, a phase shift of the high-frequency switching transistor T7 over T2 is x, and a phase shift of the high-frequency switching transistor T8 over T3 is π. Compared to conventional interleaved ANPC circuits, these embodiments share power-frequency switching transistors, thereby saving at least four power-frequency switching transistors and achieving low cost and high power density.

For the purpose of understanding the present inventive concept, the following explains a working principle of the first bridge arm circuit.

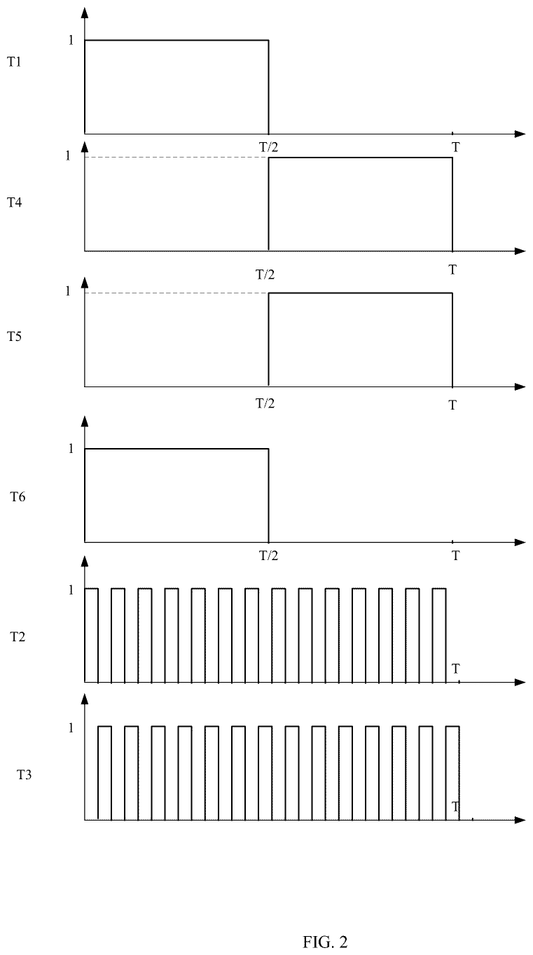

When the foregoing ANPC circuit is used as an inverter for DC-AC conversion, with reference to a pulse width modulation (PWM) waveform diagram of switching transistors T1-T6 according to some embodiments of the present inventive concept as shown in FIG. 2:

1) During a first half cycle 0-T/2, the switching transistors T1 and T6 are turned on, the switching transistors T4 and T5 are turned off, and the switching transistors T2 and T3 are alternately turned on.

When T2 is turned on and T3 is turned off, a current path is: DC+→T1→T2→L1→RY1→AC, the voltage VM1 of node M1 is the voltage UD/2 of DC+;

When T2 is turned off and T3 is turned on, a current path is: N→T6→D3 (T3)→L1→RY1→AC, the voltage VM1 of node M1 is neutral point voltage 0, where “D3 (T3)” indicates that D3 is a built-in diode of T3. Subsequent similar expressions are explained similarly.

2) During a second half cycle T/2−T, the switching transistors T1 and T6 are turned off, the switching transistors T4 and T5 are turned on, and the switching transistors T2 and T3 are alternately turned on.

When T2 is turned off and T3 is turned on, a current path is: AC→RY1→L1→T3→T4→DC−, the voltage VM1 of node M1 is the voltage −UD/2 of DC−;

When T2 is turned on and T3 is turned off, a current path is: AC→RY1→L1→D2 (T2)→T5→N, the voltage VM1 of node M1 is the neutral point voltage 0.

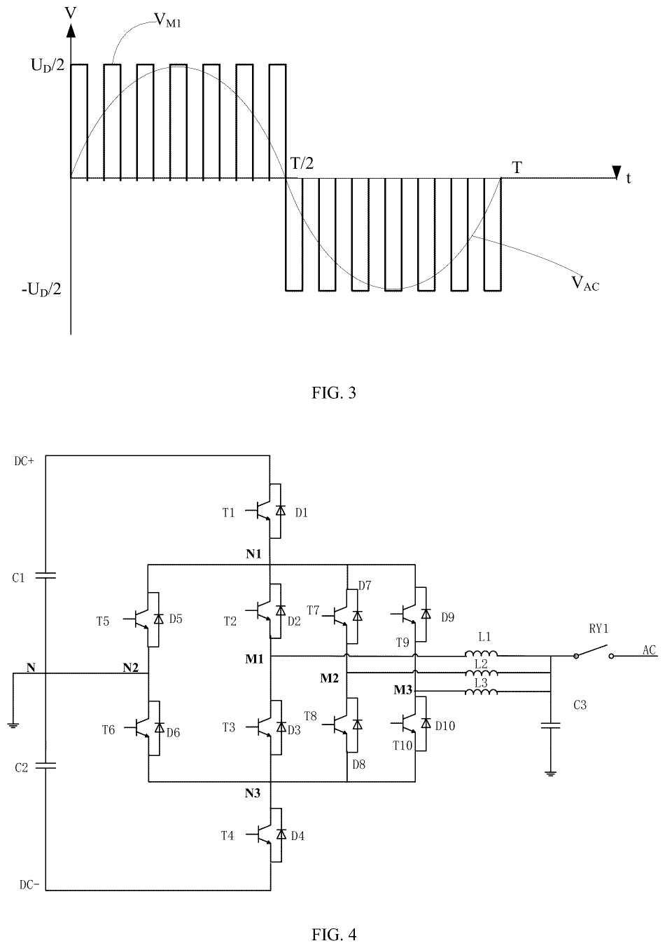

In this way, during a cycle 0-T, a pulse voltage VM1 as shown in FIG. 3 is formed at node M1, and its frequency of change is consistent with the on/off frequency of the switching transistors T2 and T3. The high-frequency pulse at node M1 is filtered by a filtering circuit composed of the inductor L1 and the capacitor C3, and then forms a sine wave voltage VAC at the output terminal AC. Therefore, when a direct current is input at the DC terminal, an alternating current can be output at the AC terminal by controlling a switching logic of the switching transistors.

When the foregoing ANPC circuit is used as an inverter for AC-DC conversion, its working principle is as follows:
(1) When the input of the AC terminal is during a positive half cycle, the input voltage of the AC terminal is filtered by L1 and C3, and the voltage of node M1 is consistent with the voltage of the AC terminal in sign:
The switching transistors T1 and T6 are turned on, the switching transistors T4 and T5 are turned off, and the switching transistors T2 and T3 are alternately turned on;
When T2 is turned off and T3 is turned on, a current path is: AC→RY1→L1→T3→D6 (T6)→N, the neutral point N is connected to node M1, and the voltage is 0;

When T2 is turned on and T3 is turned off, a current path is: AC→RY1→L1→D2 (T2)→D1 (T1)→DC+, the voltage of the DC+ terminal is consistent with the voltage of node M1, which is positive.
(2) When the input of the AC terminal is during a negative half cycle, the input voltage of the AC terminal is filtered by L1 and C3, and the voltage of node M1 is consistent with the voltage of the AC terminal in sign:
The switching transistors T1 and T6 are turned off, the switching transistors T4 and T5 are turned on, and the switching transistors T2 and T3 are alternately turned on;
When T2 is turned on and T3 is turned off, a current path is: N→D5 (T5)→T2→L1→RY1→AC, the neutral point N is connected to the node M1, and the voltage is 0;
When T2 is turned off and T3 is turned on, a current path is: DC−→D4 (T4)→D3 (T3)→L1→RY1→AC, the voltage of the DC− terminal is consistent with that of node M1, which is negative.

In this way, when an alternating current is input at the AC terminal, a control logic of the switching transistors is controlled, especially the cycle of the switching transistors T1 and T4-T6 is exactly equal to the cycle of the alternating current, a positive voltage can always be output at the DC+ terminal, and a negative voltage can always be output at the DC− terminal, so as to achieve a direct current output, thereby charging a battery.

Those skilled in the art can understand that the working principle of the second bridge arm circuit is the same as that of the first bridge arm circuit. In particular, the switching transistors T7 and T8 are π behind the switching transistors T2 and T3, respectively. When the same switching logic as above is kept at the switching transistors T1 and T4-T6, T7 and T8 are still alternately turned on, and the same power conversion process as above can be implemented.

For these embodiments, the following parameters were used for simulation experiments: DC terminal voltage 1500 V; output phase line voltage 690 V; rated power 200 kW; high-frequency switching transistors were SiC MOSFETs, with a frequency of 36 kHz; the power-frequency switching transistors were Si IGBTs (namely, IGBTs), with a frequency of 50 Hz. The simulation results show that the interleaved ANPC circuit in these embodiments can work normally, and the temperature rise characteristics of a chip are normal, indicating that sharing power-frequency switching transistors will not affect the working characteristics of the interleaved ANPC circuit.

Some embodiments of the present inventive concept provides an interleaved ANPC circuit including three parallel bridge arms, with a circuit topology as shown in FIG. 4. Compared to the circuit topology shown in FIG. 1, these embodiments add a third high-frequency switching series circuit, namely, high-frequency switching transistors T9-T10 and diodes D9-D10 anti-parallel to T9 and T10 respectively. The third high-frequency switching series circuit is connected in parallel to the first and second high-frequency switching series circuits. Specifically, an input terminal of T9 is connected to an output terminal of T1, an output terminal of T9 is connected to an input terminal of T10, an output terminal of T10 is connected to an input terminal of T4, and a node M3 between T9 and T10 is connected to the AC terminal through an inductor L3 and the relay RY1. The first, second, and third high-frequency switching series circuits are sequentially phase-shifted by 2π/3, that is, the high-frequency switching transistors T2, T7, and T9 are sequentially phase-shifted by 2π/3, and the high-frequency switching transistors T3, T8, and T10 are sequentially phase-shifted by 2π/3. Compared to conventional interleaved ANPC circuits, these embodiments share power-frequency switching transistors, thereby saving at least eight power-frequency switching transistors and achieving low cost and high power density.

Still some embodiments of the present inventive concept provides an interleaved ANPC circuit including four parallel bridge arms, a further high-frequency switching series circuit is connected in parallel based on FIG. 4, and the high-frequency switching series circuits are phase-shifted by π/2.

According to some embodiments of the present inventive concept, an interleaved ANPC circuit including N (N≥2) parallel bridge arms is provided, which shares a power-frequency switching transistor circuit and includes N high-frequency switching transistor series circuits connected in parallel to each other, where the N high-frequency switching transistor series circuits are sequentially phase-shifted by 2π/N.

In some embodiments of the present inventive concept, the power-frequency switching transistors are switching devices with low conduction losses, such as IGBTs or MOSFETs, and the high-frequency switching transistors are switching devices with low switching losses, such as SiC or GaN MOSFETs.

In the embodiments of the present inventive concept, the inductors L1, L2, and L3 respectively form LC filtering circuits together with the capacitor C3. Those skilled in the art can select inductors and capacitors according to an actual application environment. Those skilled in the art can understand that all LC filtering circuits can share capacitors, including a single capacitor or a plurality of parallel capacitors, or can use different capacitors respectively.

Those skilled in the art can understand that in some embodiments of the present inventive concept, the diodes are freewheeling diodes, which may be diodes disposed within the switching transistors or diodes disposed alone.

The interleaved ANPC circuit of the present inventive concept can achieve bidirectional power conversion with sharing power-frequency switching transistors. The interleaved ANPC circuit of the present inventive concept has a simple structure, low cost, high power density, and high thermal balance performance.

Although the present inventive concept is described through embodiments, the present inventive concept is not limited to embodiments described herein, but further includes various changes and variations made without departing from the scope of the present inventive concept.

What is claimed is:

1. An interleaved active neutral point clamped (ANPC) circuit including N parallel bridge arms, wherein N is greater than or equal to 2, the interleaved ANPC circuit comprising:
direct current (DC) terminals including a positive DC terminal and a negative DC terminal;
an alternating current (AC) terminal;
a first switching circuit connected between the positive DC terminal and the negative DC terminal and comprising a first switching transistor, a second switching transistor, a third switching transistor, and a fourth switching transistor sequentially connected in series, series nodes of the first switching transistor, the second switching transistor, the third switching transistor, and the fourth switching transistor being sequentially a first node, a second node, and a third node, wherein the second node is connected to a neutral line; and
N parallel high-frequency switching circuits connected between the first node and the third node, each of the N parallel high-frequency switching circuits comprising a first high-frequency switching transistor and a second high-frequency switching transistor connected in series, wherein a phase difference between two adjacent high-frequency switching circuits among the N parallel high-frequency switching circuits is 2π/N.

2. The interleaved ANPC circuit of claim 1, wherein frequencies of the first switching transistor, the second switching transistor, the third switching transistor, and the fourth switching transistor are power frequencies.

3. The interleaved ANPC circuit of claim 1, wherein the first switching transistor, the second switching transistor, the third switching transistor, and the fourth switching transistor are IGBTs or MOSFETs.

4. The interleaved ANPC circuit of claim 1, wherein frequencies of the first high-frequency switching transistor and the second high-frequency switching transistor are greater than or equal to 1 kHz.

5. The interleaved ANPC circuit of claim 1, wherein the first high-frequency switching transistor and the second high-frequency switching transistor are SiC or GaN MOSFETs.

6. The interleaved ANPC circuit of claim 1, further comprising N LC filtering circuits, a first terminal of each of the N LC filtering circuits is connected to a node between the first high-frequency switching transistor and second high-frequency switching transistor of a corresponding high-frequency switching circuit, and a second terminal of each of the N LC filtering circuits is connected to the AC terminal.

7. The interleaved ANPC circuit of claim 6, wherein the N LC filtering circuits share one capacitor or share a plurality of parallel capacitors.

8. The interleaved ANPC circuit of claim 1, wherein a phase difference between first high-frequency switching transistors of the two adjacent high-frequency switching circuits among the N parallel high-frequency switching circuits is 2π/N, and a phase difference between second high-frequency switching transistors of the two adjacent high-frequency switching circuits among the N parallel high-frequency switching circuits is 2π/N.

9. The interleaved ANPC circuit of claim 1, wherein the interleaved ANPC circuit is configured to perform DC-AC conversion or AC-DC conversion.

10. The interleaved ANPC circuit of claim 9, wherein the first switching circuit and the high-frequency switching circuits are configured to perform the following operations:
during a positive half cycle, the first switching transistor and the third switching transistor are turned on, the second switching transistor and the fourth switching transistor are turned off, and the first high-frequency switching transistor and the second high-frequency switching transistor are alternately turned on; and
during a negative half cycle, the first switching transistor and the third switching transistor are turned off, the second switching transistor and the fourth switching transistor are turned on, and the first high-frequency switching transistor and the second high-frequency switching transistor are alternately turned on.
